(19) United States
(12) Patent Application Publication
(10) Pub. No.: US 2014/0143729 A1
(43) Pub. Date: May 22, 2014

(54) EMERGENCY CONTACT SYSTEM

(71) Applicants: Frank Myers, Richmond, KY (US); Bob Stamper, Winchester, KY (US)

(72) Inventors: Frank Myers, Richmond, KY (US); Bob Stamper, Winchester, KY (US)

(21) Appl. No.: 14/083,817

(22) Filed: Nov. 19, 2013

Related U.S. Application Data
(60) Provisional application No. 61/727,974, filed on Nov. 19, 2012.

(51) Int. Cl. G06F 3/0482; G06F 3/0481

(52) U.S. Cl. CPC G06F 3/0482; G06F 3/04817
USPC 715/835

(57) ABSTRACT

A method is disclosed for providing information about an emergency situation to emergency personnel. The method includes prompting a user to select one of a plurality of selectable icons corresponding to a plurality of emergency situations on a database application for a communications device and configuring a plurality of emergency contacts corresponding to each of the plurality of emergency situations. The method also includes sending data corresponding to the selected one of the plurality of emergency situations from the first mobile communications device to a server, processing the data from the first mobile communications device by the server and transmitting the processed data to at least one of the plurality of emergency contacts corresponding to the selected one of the plurality of emergency situations.

This application claims the benefit of U.S. Provisional Patent Application Ser. No. 61/727,974, filed on Nov. 19, 2012, the disclosure of which is incorporated herein by reference.

### TECHNICAL FIELD

This disclosure relates generally to a communication or contact system and, more particularly, to a technology-based emergency contact system (ECS) to allow immediate and discreet connection to multiple communication platforms to distribute critical information quickly and efficiently in emergency situations.

### BACKGROUND

Emergency situations and scenarios often arise in educational, business, entertainment, social and other settings and appear to happen at a greater frequency than in the past. For example, a student may bring a weapon, such as a gun, to a primary or secondary school. Regardless of the intent of the student, this type of situation requires an immediate response with the assistance of the appropriate personnel to prevent the scenario from escalating. Of course, there are other dangerous situations that occur in schools, business, factory, warehouse and other public settings, such as fights, bullying, fires, work-related injuries, traffic accidents, other crimes and the like.

In a classroom setting which is particularly problematic due to the number of students and closed setting, an issue with a weapon is extremely dangerous. Even if the weapon is viewed by a teacher or another student in the classroom, it is difficult to convey that information in an expeditious and effective manner to the appropriate authorities to efficiently address the dangerous situation. Namely, a teacher or student typically cannot use a mobile telephone to call the appropriate authorities to address the situation without enhancing the problem, i.e., the person with the gun would likely become aware of the information being reported, which can escalate the dangerous situation.

Accordingly, a need is identified for a discreet, fast and reliable means of communicating critical information regarding an emergency situation in a public setting to the appropriate authorities to effectively diffuse a dangerous situation.

### SUMMARY

One aspect of the disclosure is a method for providing information about an emergency situation to emergency personnel. The method includes the steps of: (1) prompting a user to select one of a plurality of selectable icons corresponding to a plurality of emergency situations on a database application for a communications device; (2) configuring a plurality of emergency contacts corresponding to each of the plurality of emergency situations; (3) sending data corresponding to the selected one of the plurality of emergency situations from the first mobile communications device to a server; (4) processing the data from the first mobile communications device by the server; and (5) transmitting the processed data to at least one of the plurality of emergency contacts corresponding to the selected one of the plurality of emergency situations.

In one embodiment, the method may include collecting a user's information in the database application, such as the user's name, telephone number, address, employment or education status and the GPS location of the user. The method may further include sending the user's information from the communications device to the server and to at least one of the plurality of emergency contacts corresponding to the selected one of the plurality of emergency situations. The method may further include sending an audio or color-coded signal to the at least one of the plurality of emergency contacts corresponding to the selected one of the plurality of emergency situations.

In another embodiment, the method may further include sending the information to at least one of the plurality of emergency contacts corresponding to the selected one of the plurality of emergency situations through at least two communication platforms. Furthermore, the method may include automatically activating the user's communications device, wherein the activating step allows the at least one of the plurality of emergency contacts corresponding to the selected one of the plurality of emergency situations to view or hear the emergency situation. The method may further include classifying the user in one of a plurality of categories wherein each of the plurality of categories has different access settings.

Another aspect of the disclosure relates to a method of sending information regarding an emergency situation in a educational setting. The method includes the steps of: (1) displaying a plurality of icons corresponding to a plurality of emergency situations on a database application for a communications device; (2) configuring a plurality of emergency contacts corresponding to each of the plurality of emergency situations; (3) allowing a user to select one of the plurality of icons corresponding to the plurality of emergency situations; (4) sending data corresponding to the selected one of the plurality of emergency situations from the first mobile communications device to a computing device; and (5) transmitting the sent data to at least one of the plurality of emergency contacts corresponding to the selected one of the plurality of emergency situations. In one embodiment, the plurality of emergency situations may include fight, bullying, weapon sighted and fire and the plurality of emergency contacts may include fire department, police department and school administrator.

A further aspect of the disclosure relates to an emergency contact system. The system includes a first mobile computing device having a database for storing a plurality of emergency situations and a plurality of emergency contacts corresponding to each of the plurality of emergency situations. The system further includes a server to: (1) receive information transmitted from the first computing device corresponding to one of a plurality of emergency situations; (2) process the transmitted information from the first mobile computing device corresponding to said one of the plurality of emergency situations; (3) determine the location of the first mobile computing device based upon the transmitted information; and (4) automatically send the transmitted information to one of a plurality of emergency contacts corresponding to said one of the plurality of emergency situations.

### BRIEF DESCRIPTION OF THE DRAWINGS

The accompanying drawings incorporated in and forming a part of the specification, illustrate several aspects of this disclosure, and together with the description serve to explain the principles of the disclosure. In the drawings:

FIG. 1 is a diagram of the operation of an emergency contact system forming one aspect of the disclosure;

FIG. 2 is a flow chart of the operation of the emergency contact system forming one aspect of the disclosure; and

FIG. 3 is a diagram of an electronic amnesty form forming one aspect of the disclosure.

### DETAILED DESCRIPTION

In the following detailed description, reference is made to the accompanying drawings that form a part hereof, and in which is shown by way of illustration, specific embodiments in which the disclosure may be practiced. These embodiments are described in sufficient detail to enable those skilled in the art to practice the embodiments and like numerals represent like details in the various figures. Also, it is to be understood that other embodiments may be utilized and that process or other changes may be made without departing from the scope of the disclosure. The following detailed description is not to be taken in a limiting sense, and the scope of the disclosure is defined only by the appended claims and their equivalents. In accordance with the disclosure, an emergency contact system (ECS) is hereinafter described.

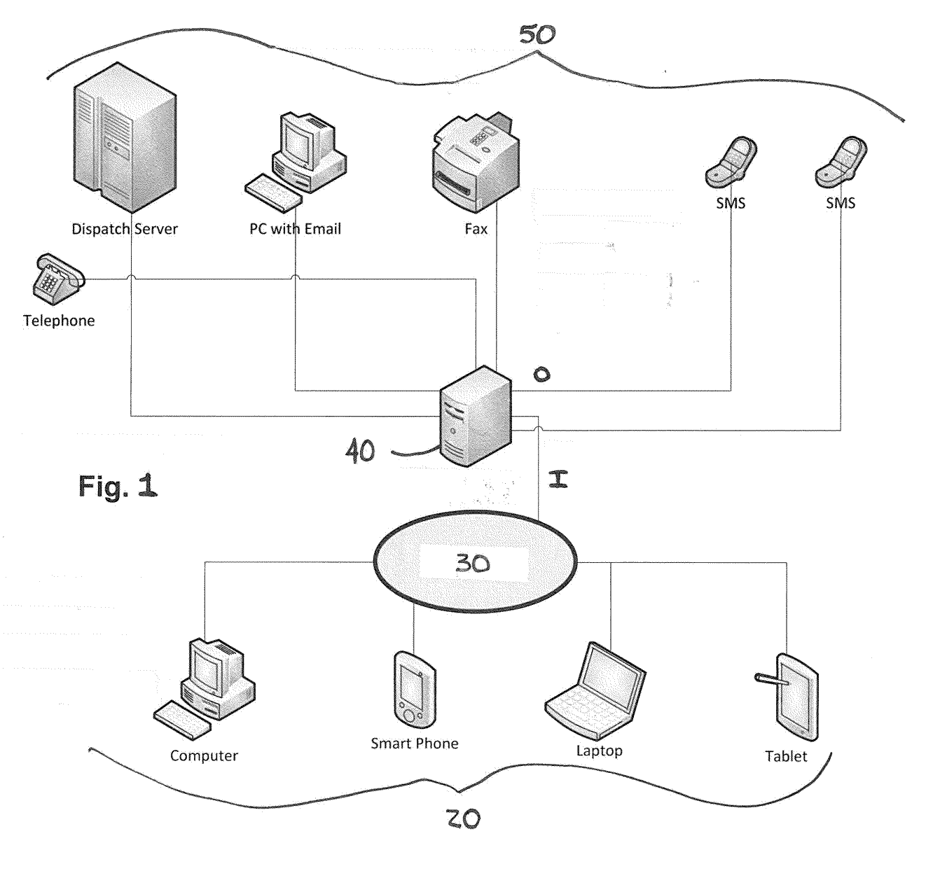

As shown in FIG. 1, an emergency contact system or ECS 10 is described. ECS is an advanced communication system that integrates several technologies to improve response times in the event of an emergency. When an emergency situation or scenario occurs, the proper authorities may be notified within seconds by a few simple clicks on a mobile electronic or computing device 20, such as a smart phone, tablet, computer or laptop computer. ECS is designed to be fast, reliable and discreet in order to promote safety by improving response times and accountability. For example, as soon as a particular scenario occurs, i.e., a person witnesses a robbery while walking down a street, the person/user may immediately enter the ECS database application 30 on his/her smart phone or tablet in a single click. The database application 30 stores a user's profile, such as name, telephone number, address, student/school or employed/employer and corresponding mobile device information for GPS tracking and location purposes.

Once the database application 30 is open, a plurality of selectable icons are displayed corresponding to multiple different emergency situations and scenarios. At this time, the user may select a particular scenario by clicking on the robbery scenario icon and hitting the submit button or icon. The information (I) is immediately sent to the ECS server 40, which then immediately processes the information and sends the output information (O) to the proper authorities such as the police via one or more communication platforms 50 or other contact means, such as telephone, dispatch server, computer, facsimile, email or SMS. Advantageously, due to the integrated GPS hardware on the smart phone or tablet, the police immediately know the location of the crime and can help in a timely manner.

In more detail, the emergency contact system 10 is a technology-based communication system for enhancing web, electronic mail (e-mail), cellular and short message service (SMS) systems to allow immediate and discreet communications to multiple recipients in the event of an emergency. Importantly, the system is capable of utilizing the latest technologies in multiple communication platforms, such as internet/wifi, cellular signals, computers, databases, smart phones, tablets and GPS location equipment in order to quickly transfer and receive emergency data between the proper authorities and civilians. In mere seconds, the system may alert the proper authorities to possible life threatening situations in educational, government, business and social settings so they can quickly and efficiently respond. Moreover, the system may be used to report crimes and traffic accidents.

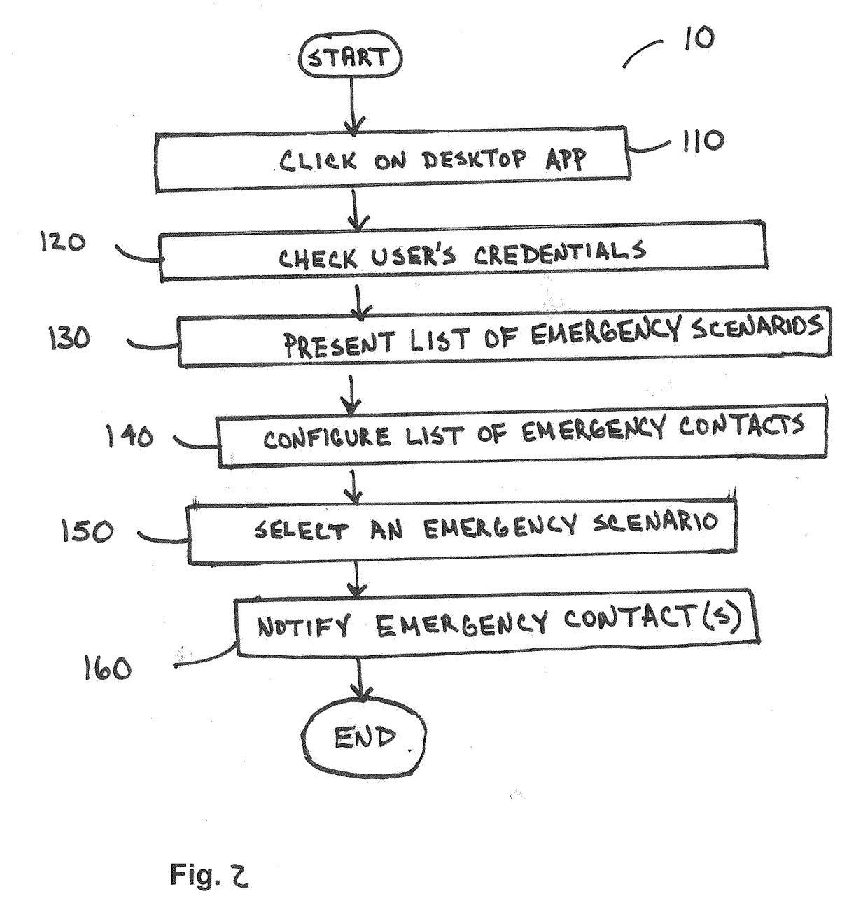

Turning to FIG. 2, the system 10 uses a multiple click sending procedure through any desktop computer, laptop computer, smart phone or tablet that run on various operating systems, including but not limited to, Windows, Apple, Android, Blackberry or Lynxx. The system 10 operates by a user clicking 110 on the desktop icon or database application (APP) icon on a first mobile electronic or computing device upon witnessing a particular scenario. The system instantly and automatically connects 120 the database to check the user's credentials such as name, phone number, GPS location and opens the application. Once the application is opened, the system presents a list 130 of emergency scenarios or situations for the user to choose from such as fire, fight, or weapon sighted. Each scenario has a list of one or more contacts attached to it. For each possible scenario, a corresponding list of contacts can be configured 140. For example, the fire scenario would correspond to the fire department contact, the fight or bullying scenario would correspond to school administrators. Scenarios may also correspond to multiple contacts, such as the weapon sighted scenario would likely correspond to both the police department and the school administrators. When a scenario is selected 150, the contacts associated with the particular scenario are immediately notified 160 according to the preferred contact method (i.e., telephone, text message, email, etc.) via the system's server, which may be internal (i.e., in a school setting) or external (such that communication is via the internet).

It should be appreciated that the list of emergency situations may be customized per school, company or organization using the system. The fire, fight and weapon sighted options are likely used in a school setting, while a business office or production line may have different settings. Each organization has the ability to create their own list of emergency situations and scenarios, which may require an immediate response from emergency personnel or other authorities. This customization feature allows for more efficiency in the operation of the business. For example, by placing specific and common injuries in a factory setting in the list of situations for a factory, the proper medical attention may be alerted in a quicker manner and responders can be better prepared for what they have to deal with before they arrive at a particular location.

Once the user chooses the particular situation applicable, a submit button will appear. Once the user selects “submit,” the system instantly collects the GPS location, time stamp, IP address and user information and sends this information along with the user ID and selected emergency to the database which contains contact information for the proper authorities and emergency responders for the particular emergency situation. Once this information enters the database, the system instantly forwards the information to the correct list of authorities and emergency responders via email, text messaging, telephone call and “push” notifications through the smart phone applications. The information sent to the authorities and emergency responders may be color-coded or have a specified audio signal corresponding to the level of the emergency. For example, a weapon sighting in a school setting may be sent in red with an audio warning indicating the seriousness of the situation while a potential lunchroom altercation may not require as much security and not require any color-coding or audio warning.

In one particular embodiment, once the emergency situation has been submitted through the ECS application, the system may automatically activate the user's device's audio and video recording system, so the proper authorities can view and hear the emergency situation. This “live reporting” feature may be accessed with the prior user's consent. This feature is particularly useful in recreating an event for the authorities or investigators. Although GPS is typically present on most smart phones, this feature is more detailed as a smart phone being held in a school generally only provides the school's address. The integrated GPS feature on the ECS application allows pin point detail regarding the precise location of the smart phone, i.e,. the cafeteria, auditorium or gymnasium.

Advantageously, the system may be integrated with federal, state and local emergency dispatch systems to allow immediate notification to police and fire departments through their already established dispatch technology. Unlike a typical 9-1-1 emergency call, smart phones with GPS can also send specific locations based on the user's actual position rather than a preconfigured database of addresses and numbers. For example, it may be appropriate to use an Indoor Positioning System (IPS) in conjunction with the system to provide floor and room locations when a scenario is submitted. In the case of a school, such an integration would allow the system to present additional information to the authorities or first responders. For instance, a teacher who is monitoring the cafeteria and witnesses a fight break out, would simply submit a fight scenario and the system would automatically notify the proper personnel or security of the scenario with the cafeteria as the location.

The system may place users into different categories having different access and permission settings. For example, a first level may be civilians that have access to the ECS application and may submit emergencies. A second level may have greater rights, such as being able to perform the activities in the first level as well as having administrator access to their ECS system. A third level may be the emergency contacts and authorities who receive the emergency information from ECS. A fourth level allows even greater access and permissions and may apply to authorities and/or civilians who have administrator access to their ECS and may cancel emergency alerts submitted by users and may send emergency alerts and instructions to all users via email, text messaging, phone calls, and “push” notifications such as a severe weather alert or evacuation instructions.

One particular setting wherein the emergency contact system is particular applicable is a school setting. For example, teachers and students may utilize the emergency contact system for fast, discreet and reliable means of communicating critical information to appropriate personnel. Of course, it should be appreciated that the emergency contact system can be used in a wide variety of environments other than schools and universities, but also government organizations, business, warehouse and factory settings as well as public events, such as movie theaters, concerts and athletic events. In one embodiment, the emergency contact system incorporates two distinct routing sets, one for teachers and another for students. The particular routing sets may be varied such that the teachers have a broader communication scope that the students. Furthermore, the list of possible emergency scenarios and the corresponding contact lists are completely customizable to fits the needs of each location or school.

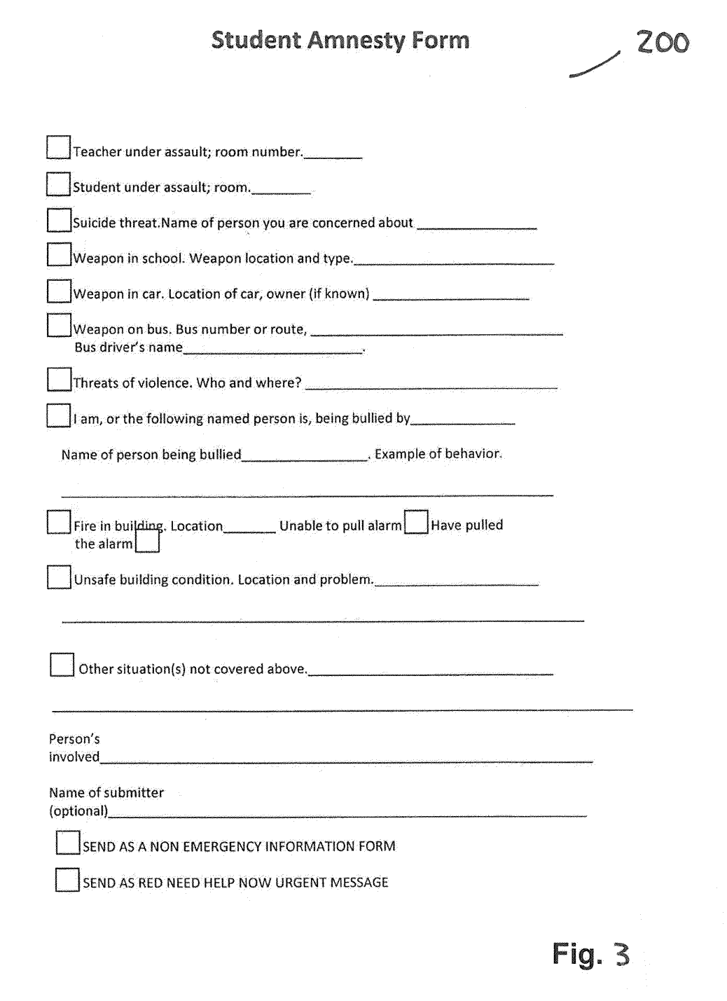

As shown in FIG. 3, one feature of the system is an “electronic amnesty box” 200. While it may be used in any setting, it is particularly suitable for the school environment as it is mobile application for smart phones and computers whereby students are able to quickly and discreetly report issues to school officials, such as when they see bullying or a person that that may present danger to self or others. The electronic amnesty box 200 consists of a copyright electronic form that allows a student or other user to select a particular situation in seconds and submit electronically the form to the school administration.

The system can be integrated into any location as a hosted service where the “second computing device” is housed in a hosting or colocation facility. The “first computing device” can be any personal computer, MAC or smart phone already in use at the facility. The system can also be completely housed at a facility where the “second computing device” is actually located at the customer's location. In this situation, it would be a server configured for the sole purpose of handling and routing the scenarios. The benefits of an in-house configuration include authentication systems, such as Microsoft Active Directory, and would allow for hard wired panic button style input devices. Hybrid installation systems are also possible wherein relay switches are connected to a local server, which transmits the information to the hosted or collocated server off-site. In each of these situations, it should be appreciated that the user's personal computer, MAC or smart phone computing devices are being referred to as the “first computing device.” In other words, the system may include a hosted server located on site that all communications run through it. On the other hand, the system may utilize an external server such that all communications run through it via the internet.

The foregoing descriptions of various embodiments are provided for purposes of illustration, and are not intended to be exhaustive or limiting. Modifications or variations are also possible in light of the above teachings. The embodiments described above were chosen to provide the best application to thereby enable one of ordinary skill in the art to utilize the disclosed inventions in various embodiments and with various modifications as are suited to the particular use contemplated. All such modifications and variations are within the scope of the disclosure.

1. A method for providing information about an emergency situation to emergency personnel, comprising:
prompting a user to select one of a plurality of selectable icons corresponding to a plurality of emergency situations on a database application for a communications device;
configuring a plurality of emergency contacts corresponding to each of the plurality of emergency situations;
sending data corresponding to the selected one of the plurality of emergency situations from the first mobile communications device to a server;
processing the data from the first mobile communications device by the server; and
transmitting the processed data to at least one of the plurality of emergency contacts corresponding to the selected one of the plurality of emergency situations.

2. The method of claim 1, further comprising: collecting a user's information in the database application.

3. The method of claim 2, wherein the collecting step includes determining a GPS location of the user.

4. The method of claim 2, further comprising: sending the user's information from the communications device to the server and to at least one of the plurality of emergency contacts corresponding to the selected one of the plurality of emergency situations.

5. The method of claim 2, wherein the user's information includes the user's name, telephone number, address and employment or education status.

6. The method of claim 1, wherein the transmitting step further includes sending an audio signal to the at least one of the plurality of emergency contacts corresponding to the selected one of the plurality of emergency situations.

7. The method of claim 1, wherein the transmitting step further includes sending an color coded signal to the at least one of the plurality of emergency contacts corresponding to the selected one of the plurality of emergency situations.

8. The method of claim 1, wherein the transmitting step includes sending the information to at least one of the plurality of emergency contacts corresponding to the selected one of the plurality of emergency situations through at least two communication platforms.

9. The method of claim 1, further comprising automatically activating the user's communications device.

10. The method of claim 10, wherein the activating step allows the at least one of the plurality of emergency contacts corresponding to the selected one of the plurality of emergency situations to view the emergency situation.

11. The method of claim 10, wherein the activating step allows the at least one of the plurality of emergency contacts corresponding to the selected one of the plurality of emergency situations to hear the emergency situation.

12. The method of claim 2, further comprising classifying the user in one of a plurality of categories wherein each of the plurality of categories has different access settings.

13. An emergency contact system, comprising:
a first mobile computing device having a database for storing a plurality of emergency situations and a plurality of emergency contacts corresponding to each of the plurality of emergency situations; and
a server to: receive information transmitted from the first computing device corresponding to one of a plurality of emergency situations; process the transmitted information from the first mobile computing device corresponding to said one of the plurality of emergency situations; determine the location of the first mobile computing device based upon the transmitted information; automatically send the transmitted information to one of a plurality of emergency contacts corresponding to said one of the plurality of emergency situations.

14. The system of claim 13, wherein the server is remote from the first mobile computing device.

15. The system of claim 14, wherein the information is transmitted from the first computing device to the server via the internet.

16. The system of claim 13, wherein the server automatically activates the first mobile computing device to obtain additional information about the one of the plurality of emergency situations.

17. The system of claim 13, wherein server sends the transmitted information to one of the plurality of emergency contacts corresponding to said one of the plurality of emergency situations via facsimile, telephone or text message.

18. A method of sending information regarding an emergency situation in a educational setting, comprising:
displaying a plurality of icons corresponding to a plurality of emergency situations on a database application for a communications device;
configuring a plurality of emergency contacts corresponding to each of the plurality of emergency situations;
allowing a user to select one of the plurality of icons corresponding to the plurality of emergency situations;
sending data corresponding to the selected one of the plurality of emergency situations from the first mobile communications device to a computing device; and
transmitting the sent data to at least one of the plurality of emergency contacts corresponding to the selected one of the plurality of emergency situations.

19. The method of claim 18, wherein the plurality of emergency situations include fight, bullying, weapon sighted and fire.

20. The method of claim 18, wherein the plurality of emergency contacts include fire department, police department and school administrator.
